(19) United States
(12) Patent Application Publication
(10) Pub. No.: US 2006/0180364 A1
(43) Pub. Date: Aug. 17, 2006

(54) Method for transporting electric energy

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/516,794

(22) PCT Filed: May 28, 2003
(86) PCT No.: PCT/EP03/05619

§ 371 Date: Aug. 12, 2005

(30) Foreign Application Priority Data
Jun. 5, 2002 (DE) 102 24 808.7

(51) Int. Cl. B60K 1/00

(52) U.S. Cl. 180/65.3

(57) ABSTRACT

An apparatus for and a method of transporting electrical energy. In one embodiment a storage device formed from a plurality of storage elements is arranged as a payload on and/or in a vehicle or craft, wherein in the delivery of the electrical energy the storage device remains on and/or in the vehicle and the vehicle has a connection for transmitting the stored electrical energy upon discharge.

### BACKGROUND OF THE INVENTION

1. Field of the Invention

This disclosure concerns an apparatus for and a method of transporting electrical energy.

2. Description of the Related Art

Electrical conductors are used almost without exception as apparatuses for transporting electrical energy. However electrical conductors are only limitedly suitable for transport over relatively long distances as the losses in such conductors rise with increasing length and make energy transport when long distances are involved uneconomical.

Alternatively electrical energy is used to perform a chemical process such as electrolysis which results in a desired substance such as for example hydrogen. That substance can be transported to a destination and there converted into electrical energy again by a suitable apparatus such as for example a fuel cell. That situation however involves transporting not electrical energy but an energy carrier, the production of which on the one hand and the conversion into electrical energy of which on the other hand involves losses.

In addition it has long been known for electrical energy which is required for the operation of apparatuses to be carried on or in such apparatuses in suitable storage devices. By way of example reference may be made here to a motor vehicle which includes a lead accumulator which provides the electrical energy required for the start-up process. A further example is for example mobile telephones which are provided with accumulators for providing the energy required for operation thereof. Those examples however always involve suitably carrying around energy which is required by the unit itself.

### BRIEF SUMMARY OF THE INVENTION

In one aspect, a storage device comprises a plurality of storage elements and is arranged as a payload on and/or in a vehicle or craft, wherein in the delivery of the electrical energy the storage device remains on and/or in the vehicle and the vehicle has a connection for transmitting the stored electrical energy upon discharge.

In another aspect a method comprises:
charging the storage device with electrical energy;
transporting the vehicle to a destination; and
discharging the storage device at the destination.

In one embodiment, accumulators and/or capacitors are provided as storage elements. These are common storage elements and are also available in large numbers. In addition use in the event of damage is thus reliably possible.

In another embodiment a plurality of storage elements are combined together mechanically and/or electrically to form storage device groups. By virtue of that combination, on the one hand they can be charged or discharged at the same time and/or in the case of replacement they can be handled as a complete group without each storage element having to be handled individually. That is particularly advantageous if the storage device comprises a very large number of storage elements so that access to an individual storage element is very complicated and expensive. In this case a storage device group in which the storage element which is being sought is included can be rapidly removed from the storage device and replaced by a new, faultless storage device group. The vehicle can then complete its journey with at worst a slight delay.

In another embodiment the vehicle drive can be operated with the stored energy. This means that there is no need for the vehicle to also carry an additional storage device, for example in the form of a tank with fuel. It will be appreciated that nonetheless a limited supply of fuel and an internal combustion engine can be carried along in order to permit an emergency drive.

In order to permit speedy charging or discharging of a storage device, there can be provided fixed stations at which intermediate storage devices are arranged. Thus a vehicle can firstly deliver its charge to that intermediate storage device and immediately leave the station again in order to pick up further charges. Then, as required, the energy can be forwarded from the station or the intermediate storage device and fed into a network.

In another embodiment of the invention there can be provided a collective connection for a plurality of storage elements and/or storage device groups. In that way, a plurality of storage elements or storage device groups can be simultaneously charged/discharged, in which case it is possible to save on the time for making the electrical connections to each individual storage element.

In one aspect, when accumulators which contain an electrolyte fluid are used as the storage elements, it is possible to save on a considerable part of the weight of the storage device by removing the fluid so that the fluid is not contained in the accumulators during the transport procedure. For that purpose each storage element may have an opening. In that way, the required drive power is reduced or, if the carrying capacity of the vehicle is fully utilized, the amount of energy which can be transported is increased.

In order not to have to drain off the fluid separately at each individual storage element, the openings of a plurality of storage elements can be connected together by collecting conduits. That also affords a time saving when filling or draining off the fluid.

If, when draining off the fluid, the fluid is firstly collected in a container on board the vehicle, that fluid, after having been drained out of the storage elements, can be taken off the vehicle with that container in one working operation or, prior to filling of the storage elements, the fluid can be put on board in one working operation and preliminary treatment procedures or subsequent treatment procedures can be carried out independently of the vehicle and without influencing the travel schedule thereof. If the vehicle for transporting a battery storage device is for example a ship, then that ship can already cast off, after charging of the storage device, and begin the journey to the destination port, while the electrolyte is being drained out of the batteries and collected in a container (or a plurality of containers).

As soon as the electrolyte is drained out of all storage elements, that container can be transferred for example with an on-board loading apparatus on to another ship which carries the fluid back to land for preparation and storage. With suitable container sizes, that task can also be performed by an aircraft such as for example a helicopter.

A preliminary treatment or a subsequent treatment can involve for example cleaning the fluid in order to remove suspended substances therein. In that way accumulators are filled with a clean electrolyte and the sludge which with an increasing service life limits the accumulators or the efficiency thereof cannot become deposited. That increases the service life of the storage elements, with a high capacity.

### BRIEF DESCRIPTION OF THE SEVERAL VIEWS OF THE DRAWINGS

Embodiments by way of example of the invention are described in greater detail hereinafter with reference to the drawings in which:

FIG. 1 shows a storage device according to the invention on board a ship,

FIG. 2 shows an embodiment of a storage device group according to the invention, and

FIG. 3 shows a simplified view of the procedure involved in energy transport according to the invention.

### DETAILED DESCRIPTION OF THE INVENTION

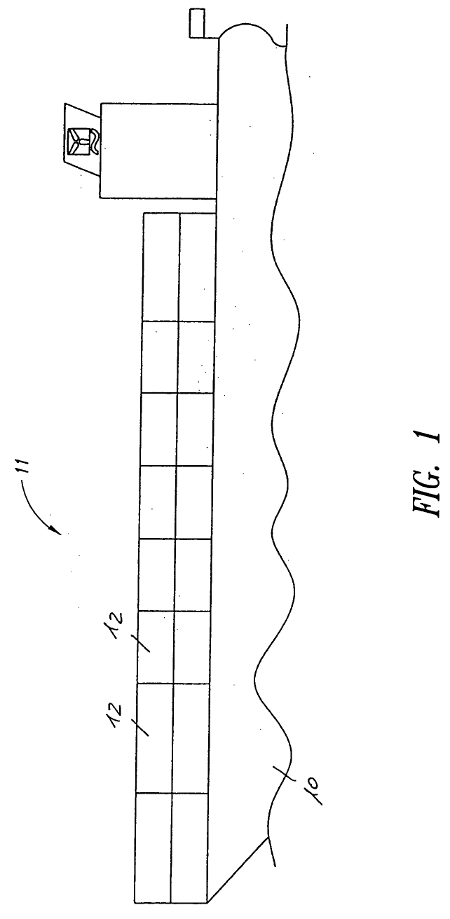

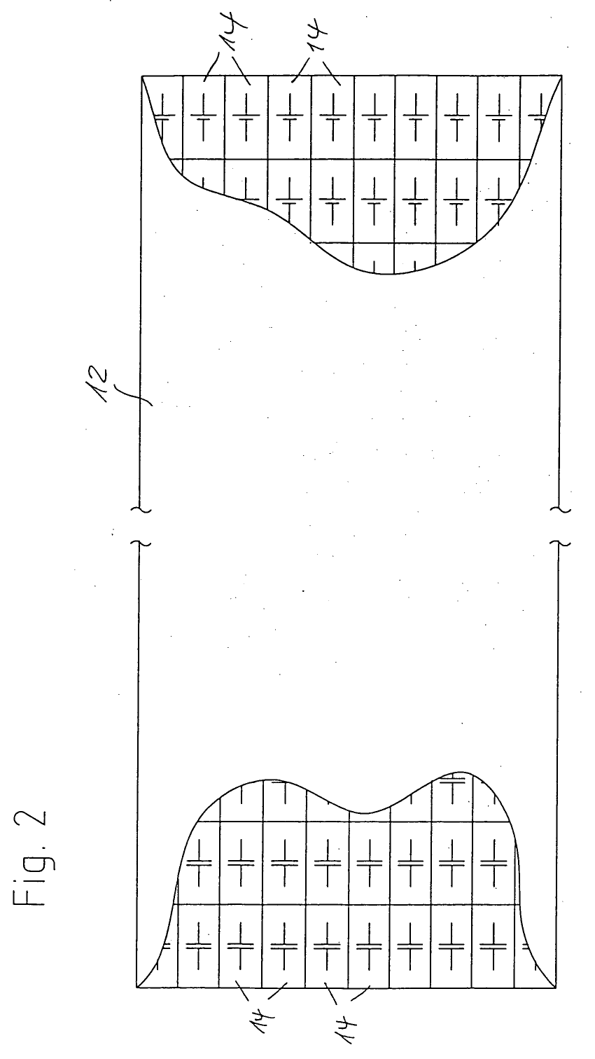

FIG. 1 shows a ship 10 as a transport vehicle or craft for a storage device 11 according to the invention. That storage device 11 is made up of a plurality of storage elements (see FIG. 2), which are combined together in grouped relationship in containers 12. The containers 12 can be for example commercially usual containers, which can be transported on known and available container ships, both below deck, in cargo spaces and also as deck load. In that way considerable amounts of storage devices 11 can be transported with such a ship 10.

In order to charge up or discharge the storage devices 11 it is sufficient to provide a suitable connection (not shown) at the outside of each container 12. If storage elements (see FIG. 2) should turn out to be defective, the container 12 in question with the defective storage device can be unloaded and replaced by a substitute container using standard loading equipment such as container bridges or container spreaders, so that the turnaround time of the ship 10 is not prolonged to any degree worth mentioning, even if storage elements have to be replaced. In a corresponding manner for example when using accumulators as the storage elements, the electrolyte fluids can be respectively introduced and drained off in container-wise fashion in each case by way of collecting conduits in order in that way to reduce the weight of the storage device 11 during the journey.

FIG. 2 shows a partially cut-open view of such a container 12 with storage elements 14 arranged therein in such a way as to fill up the space. In the left-hand part of FIG. 2 the storage elements 14 are shown in the form of capacitors such as for example high-capacity ultra-capacitors. In the right-hand part of FIG. 2 the storage elements 14 are shown in the form of accumulators, for example lead accumulators. That clearly shows the many different possible ways of constructing the storage device. It will be appreciated that basically it is possible to use any suitable storage elements 14.

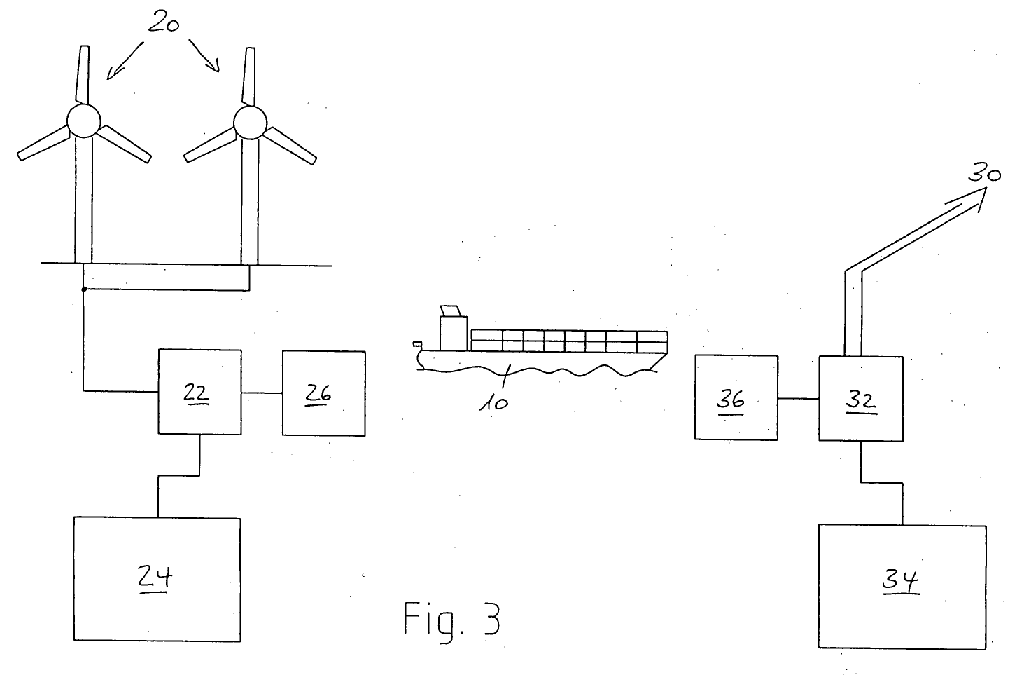

FIG. 3 shows the method according to the invention. The left-hand part of the Figure shows wind power installations 20 which continuously generate electrical energy. That electrical energy is stored in an intermediate storage device 24 by way of a control 22. If now a ship 10 or the storage devices 11 thereof are to be charged up the storage devices 11 are connected to the connecting station 26 and the control 20 causes a flow of current from the intermediate storage device 24 and/or the wind power installations 20 to the connecting station 26 and to the storage device on board the ship 10.

As soon as the storage device on board the ship 10 is charged up, then, in the case of lead accumulators, the electrolyte can be drained off and cleaned and then stored in a tank. The ship 10, with the charged storage devices but without electrolyte, can then steer for its destination port. There it is once again connected to a connecting station 36. If necessary electrolyte which is stored there can again be filled into the lead accumulators and the discharge operation begins. In that case there is once again provided a control 32 which firstly causes a flow of current from the storage device into an intermediate storage device 34 and/or straightaway into a network 30 in which the electrical energy can then be consumed.

For the return journey the electrolyte can then be removed again from the storage device, which has been discharged in the meantime.

From the foregoing it will be appreciated that, although specific embodiments of the invention have been described herein for purposes of illustration, various modifications may be made without deviating from the spirit and scope of the invention.

1. An apparatus for receiving and transporting electrical energy, comprising:
a storage device formed from a plurality of storage elements;
a vehicle having a connection for receiving electrical energy from an external source and for transmitting electrical energy from the storage device to an external load, wherein the storage device is arranged as a payload for the vehicle and in the receiving and transmitting of the electrical energy the storage device remains arranged as a payload for the vehicle.

2. The apparatus as set forth in claim 1 wherein the storage elements comprise accumulators.

3. The apparatus as set forth in claim 1 wherein the plurality of storage elements are combined to form storage device groups.

4. The apparatus as set forth in claim 3 wherein a vehicle drive is operable with stored energy.

5. The apparatus of claim 1, further comprising:
fixed stations for charging up and discharging the storage device.

6. The apparatus of claim 5 wherein the fixed stations comprise:
intermediate storage devices for intermediate storage of the electrical energy.

7. The apparatus of claim 1, further comprising: at least one electrical collective connection for a plurality of storage elements.

8. The apparatus of claim 1, further comprising: at least one opening in each storage element for introducing or draining off a fluid.

9. The apparatus of claim 8 further comprising one or more collecting conduits which connect the openings of the storage elements together.

10. The apparatus of claim 9 wherein the collecting conduit opens into a container on board the vehicle.

11. The apparatus of claim 1, further comprising: a device for monitoring individual storage elements.

12. The apparatus as set forth in claim 11 wherein the monitoring device is configured to indicate an operating condition of at least one of individual storage elements or storage device groups.

13. The apparatus of claim 11 wherein the monitoring device is arranged on board the vehicle.

14. The apparatus of claim 11 wherein the device includes at least a microprocessor and a memory.

15. A method of storing and transporting electrical energy by means of a vehicle carrying an electrical storage device as a payload, comprising the steps of:
receiving electrical energy from a source external to the vehicle;
charging the storage device with the received electrical energy;
transporting the vehicle to a destination; and
discharging the storage device at the destination.

16. The method as set forth in claim 15, further comprising:
draining a fluid contained in the storage device after charging of the electrical energy into the storage device but prior to transport of the storage device to the destination; and
introducing a fluid into the storage device after transport of the storage device to the destination but prior to removal of the electrical energy fluid.

17. The method as set forth in claim 16 further comprising:
cleaning the fluid after removal; and storing the cleaned fluid.

18. The method as set forth in claim 15, wherein transporting the vehicle to a destination comprises removing a container of storage device fluid from the vehicle.

19. The method as set forth in claim 16 further comprising:
monitoring a number of charge/discharge cycles for each storage elements; and outputting a corresponding notification when a predetermined number of cycles is reached.

20. The apparatus as set forth in claim 1 wherein the storage elements comprise capacitors.

21. The apparatus of claim 1, further comprising:
fixed stations for converting the electrical energy.

22. The apparatus of claim 1, further comprising:
a device for controlling a charging/discharging operation.

23. The apparatus of claim 1, further comprising:
a device for supplying or removing fluid.

24. The apparatus of claim 1, further comprising a device for controlling the charging/discharging operation and for supplying or removing fluid.

25. A vehicle, comprising:
means for storing electrical energy received from an external source at a first location; and
means for discharging the stored electrical energy at a second location.
